(19) United States
(12) Patent Application Publication
(10) Pub. No.: US 2017/0230242 A1
(43) Pub. Date: Aug. 10, 2017

(54) Dynamic Elastic Shadow Service Orchestrator

(71) Applicant: Yaana Technologies, LLC, Milpitas, CA (US)

(72) Inventors: Michael P. Hammer, Reston, VA (US); Rajesh Puri, Fremont, CA (US); David Grootwassink, Safety Harbor, FL (US); Curt Schwaderer, Urbandale, IA (US); Amit Misra, Milpitas, CA (US)

(73) Assignee: Yaana Technologies, LLC, Milpitas, CA (US)

(21) Appl. No.: 15/430,424

(22) Filed: Feb. 10, 2017

Related U.S. Application Data
(60) Provisional application No. 62/293,739, filed on Feb. 10, 2016.

(51) Int. Cl. H04L 12/24; G06F 9/44; H04L 29/08

(52) U.S. Cl. CPC H04L 41/0806; H04L 41/048; H04L 41/0893; H04L 67/1097; G06F 9/4401

(57) ABSTRACT

An augmented telecommunication system including a network including virtual network functions. The system also includes a secondary agent located on the network. Also, the system includes a node discovery server in communication with the secondary agent over the network, a node configuration server in communication with the secondary agent over the network, and a node search server in communication with the secondary agent over the network. The secondary agent monitors information passing over the network.

### CROSS-REFERENCE TO RELATED APPLICATIONS

This application claims the benefit of U.S. Provisional Application No. 62/293,739, entitled Dynamic Elastic Shadow Service Orchestrator, and filed Feb. 10, 2016, which is herein incorporated by reference in its entirety.

### FIELD

The present disclosure relates in general to telecom networks and systems. In particular, the present disclosure relates to a system and method for dynamic discovery and connectivity of shadow derivative service agents using a dynamic elastic shadow service orchestrator.

### BACKGROUND

Networks in the past were built using hardware appliances. Those networks include: wireline and wireless, circuit-switched and packet-switched, fixed and mobile cellular; supporting both telecommunications and Internet designs. Today, the paradigm is shifting from the appliance model to the cloud model, where the network functions are virtualized as applications running on generic hardware. The benefits of the cloud model enable lower cost hardware, dynamic generation of virtual network functions (VNF), and elastic capacity through either resizing resource allocations or by spawning up additional VNFs to meet demand. Much work is being done across the networking and telecommunications industry under the banner of Network Functions Virtualization (NFV) and Software Defined Networking (SDN) to define how such functions can be instantiated top-down via management and orchestration controllers.

However, such top-down approaches suffer from some key problems. First, they assume that all the information needed to fully instantiate a VNF is fully known in advance and can be pre-planned. Given that some of the variables may only be known after instantiation, there needs to be the ability to adapt to the new environment hosting the VNF. Second, some of the configuration or provisioning of the VNF may only occur once those environmental variables are known. Third, some of the configuration inputs may be sensitive and cannot be shared prior to instantiation and cannot be visible to the hypervisor and the standard management and orchestration components (e.g. Management and Orchestration architecture (MANO): Virtual Functions Manager (VFM), Virtual Infrastructure Manager (VIM), Network Functions Virtualization Orchestrator (NFVO)). The MANO includes the NFVO, VFM, and VIM. Fourth, due to mobility and the elastic nature of the underlying components, along with the mobility of user traffic and the nodes that support them, agents need to adapt.

What is needed is a system and method that is dynamic and allows the system to adopted to a new environment hosted by a VNF.

### SUMMARY

Briefly, and in general terms, various embodiments are directed to an augmented telecommunication system including a network including virtual network functions. The system also includes a secondary agent located on the network. Also, the system includes a node discovery server in communication with the secondary agent over the network, a node configuration server in communication with the secondary agent over the network, and a node search server in communication with the secondary agent over the network. In certain embodiments, the system includes a plurality of virtual agents on the network that are in communication with the secondary agent on the network. The secondary agent monitors information passing over the network. In certain embodiments, the secondary agent intercepts targeted information passing over the network and may relay it to the other virtual agents for analysis

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 depicts one exemplary shadow service orchestration system.

FIG. 2 depicts an exemplary system for intercepting communications from a target device over a network.

FIG. 3 depicts a flow chart of one example of a method for intercepting communications from a target device over a network.

FIG. 4 depicts an exemplary computer architecture that may be used for one embodiment of communication system.

### DETAILED DESCRIPTION

The present disclosure describes a system and method for providing a dynamic elastic shadow service orchestrator. In one embodiment, the present system and method allow for dynamic discovery and connectivity of shadow derivative service agents. The present system elastically spawns additional service agents to support downstream data processing capacity due to expanded activity and data export from data originating service agents. According to one embodiment, the present system is used in embedded element agents that appear associated with virtual network functions where partitioning of security domains preclude top-down orchestration approaches for advance provisioning of bootstrapping details.

In such cases, where the full configuration cannot be planned in advance, the instantiation is performed in two stages, according to one embodiment. The first stage is a base instantiation according to the pre-planned MANO infrastructure. The second stage requires a secondary orchestrator or dynamic elastic shadow service orchestrator that adapts to the discovered local variables and manages the additional configuration of agents within the host application system. In addition, the dynamic elastic shadow service orchestrator may assist sensitive agents to adapt to changes in the primary system.

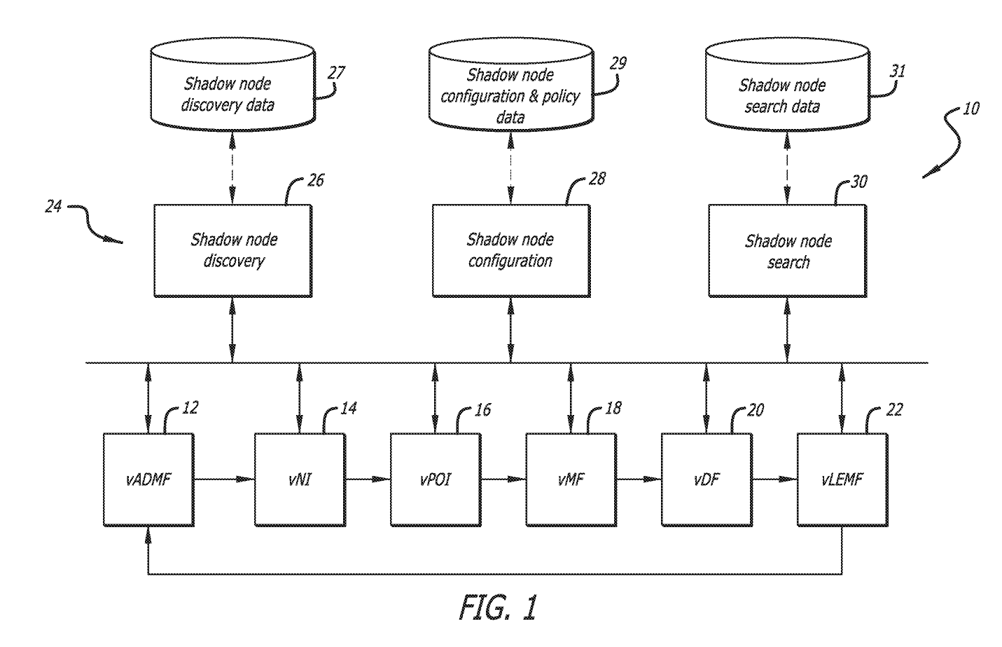

According to one embodiment, FIG. 1 shows the components of the shadow service orchestration (SSO) 10 along with an exemplary embodiment involving lawful shadow agents in the network.

FIG. 1 illustrates a number of unconfigured agents or virtual agents including vADMF (virtual administrative functions) 12; vNI (virtual network intelligence functions) 14, such as a signaling monitor; vPOI (virtual point of interception functions) 16, such as Deep Packet Inspection (DPI); vMF (virtual mediation functions) 18; vDF (virtual delivery functions) 20; and vLEMF (virtual law enforcement monitoring functions) 22. The vADMF 12 is the administrator for the legal intercept NFV functions, and may be a virtual function. In one embodiment, the vNI 14 interfaces with network infrastructure routing control elements to manipulate traffic paths for a list of subscribers. The vNI 14 may be located on or in close communication with the primary network elements that manage primary service flows. The vPOI 16 interface with points within the network infrastructure to identify and acquire relevant traffic streams. In certain embodiments the vPOI 16 may be configured to extract meta data based on all traffic flowing over the network links for mass acquisition and analytics purposes. The vPOI 16 may be located on or in close communication with the primary nodes that it taps. Also, the vMF 18 may process the traffic delivered from the acquisition agents to transform the traffic into a standard format for ingestion.

Data store servers in communication with the virtual agents receive mediated data and meta data and may ingest, index, and store. In one embodiment, the meta data, such as caller or callee information, as well as call content, are extracted by the vPOI 16 and sent to the vMF 18 in raw form and then to the vDF 20, which manages delivery to one or more monitoring facilities, the vLEMF 22. The vLEMF 22 may index and store the meta data. In one embodiment, the vMF 18 and vDF 20 act as a buffers.

Other than the vNI 14 and vPOI 16, the other virtual agents may be scaled independently of the primary network to support legal intercept functions. These virtual agents, including the vMF 18 and vDF 20, also may be located remotely in a more secure cloud due to their sensitive nature. Thus, while the vNI 14 and vPOI 16 acquire information on the network, the vMF 18 and vDM 20 are delivery functions that deliver information to the vLEMF 22, which collects and monitors targeted information.

In one embodiment, the unconfigured or virtual agents may also include various management agent servers, such as a configuration agent, a fault detection agent, an accounting agent, a performance monitor agent, or a security agent. In certain embodiments, the purpose of the virtual agents may be either to support management functions, or to support network operation functions, or to support application auxiliary functions. Each of the virtual agents are initially configured by the primary NFV MANO with the address and credentials needed to contact the secondary shadow service orchestration components 24. The MANO is responsible for loading the primary node NFV into the Cloud NFV Infrastructure. In one embodiment, the MANO assigns compute, store, network access resources to the primary node. The primary node NFV package includes many components, one of which is the secondary agent used for intercepting communications. In one embodiment, the MANO does not know what is in the NFV package, the MANO is only informed that it is a proper signed validated binary object. Once the primary NFV node boot-straps, it launches internal processes, one being the secondary legal intercept agent we embed on the network. The second agent learns its current location, then contacts the shadow orchestrator directly through a secure connection (e.g., TLS) bypassing MANO functions. In this embodiment, MANO is kept out of the loop for security reasons.

In one embodiment, the virtual agents may be embedded in other virtual network functions that upon activation spawn the initiation of the virtual agents. Once spawned, the virtual agents may learn their current locations, and then contact the shadow orchestrator directly through a secure connection (e.g., TLS) to bypass MANO functions. In another embodiment, the virtual agents may be stand-alone virtual network functions that are spawned by a server, such as a shadow node configuration component or server (discussed below) through requests to the MANO. In this embodiment, the primary NFV just installed on the network or the shadow orchestrator could ask the MANO to provide a new virtual machine (compute, storage, or network) to support a new binary VNF object or application to be installed and started. In this embodiment, the MANO may not know what functions are performed by the VNF. In an embodiment the virtual agents may be pre-provisioned with boot-strapping information, such as authentication credentials (e.g., crypto-based certificates) and the network address of the home shadow node discovery component or server to contact. Also, this boot-strapping information may include cryptographic material enabling it to establish encrypted confidential paths back to the home shadow node components or servers.

In one embodiment, any of the above-identified virtual agents may be embedded in any virtual network function, such as eNodeB (base stations), mobility management entity (MME), serving or gateway GPRS (General Packet Radio System) serving nodes (SGSN, GGSN, serving gateway (SGW), packet data network (PDN) gateway (PGW), home location register (HLR), home subscriber server (HSS), or other mobile network or fixed network server components.

Specifically, the virtual agents contact a shadow node discovery component 26 to register themselves. The shadow node discovery component 26 is responsible for registering the virtual agent nodes. The shadow node discovery component 26 is associated with a discovery data 27 to assist in validating the authenticity of the virtual agents. The discovery data 27 enables any node to be able to discover other virtual nodes and communicate with them, subject to policy controls on visibility between virtual nodes. The shadow node discovery component may be a server and the discovery data may be any type of memory associated with the server.

The shadow node configuration or provision component 28 is responsible for managing configuration and policy data for each of the virtual nodes depending on type, communication service provider, law enforcement agency, jurisdictional location, and other factors that determine how each should be configured and what data should be visible to each virtual node. The shadow node configuration component 28 is associated with configuration and policy data 29 to assist in configuring agents. This enables the adaptation of the virtual agent relative to the primary nodes and network environment. The shadow node configuration component may be a server and the configuration and policy data may be any type of memory associated with the server.

In one embodiment, the configuration and policy data 29 includes parameters of operation of the virtual agents enabling them to transform from an unconfigured state to a configured state (provisioned). The configuration and policy data may also include network operator, jurisdiction, and geolocation parameters. Furthermore, the configuration and policy data may include parameters such as data transmission policies governing what can be transmitted and how packets should be marked for quality of service (QoS). In one embodiment, real-time streamed data, such as voice call content, is given highest priority since voice packets may be dropped by jitter buffers if they arrive after 200 milliseconds. Signaling messages or other non-real-time traffic may be assigned lower priority. Network operators may give legal intercept flows similar treatment. Provisioning or management flows may have higher or lower priority as desired. In one embodiment, each packet flow receives an assignment and the second or legal intercept agents need to know how to tag each packet.

In certain embodiment, the configuration and policy data includes parameters such as assigned work group and neighbors from which to receive data connection requests and which neighbors to which it can request connections. In one example, the vPOI 16 may connect to one vMF 18 but not others on the network. In this example, the vMF 18 may connect to one vDF 20 but not others on the network. The virtual agents should know which shadow orchestrator to connect to, since nodes are supporting traffic load, the network graph should be balanced. In addition, the configuration and policy data includes parameters such as assigned shadow node managing servers, such as servers 26, 28, and 30, from which it receives instructions for provisioning or reconfiguration, and to which it provides reports on agent status, operating parameters, information about the associated or embedded primary node. In one embodiment, the configuration and policy data includes parameters such as start and end times for operations, or schedules for any type of activity associated with its internal functions. The configuration and policy data also may include parameters such as whether it can spawn additional virtual gents to support scaling out. Also, the configuration and policy data may include parameters such as whether it can request additional compute, storage, or communications resources from the MANO to support scaling up. In certain embodiment, the configuration and policy data includes parameters such as information that it can request from a host VNF. In one example, the host VNF may provide information about how much compute, storage, network resources may be used by the embedded agent. The host VNF also may send to the embedded agent an external address so that the embedded agent can provide a return address to the shadow orchestrator. The host VNF may provide additional information to the embedded agent, including the node type of the host, e.g., SGW, PGW, etc., or other parameters, such as information concerning the associated telecom network of the VNF. The configuration and policy data may include parameters such as what information it can share with its host VNF concerning any of the virtual agent's internal operation. In yet another embodiment, the configuration and policy data includes parameters such as target information regarding the numbers and types of traffic or processes on which it should perform monitoring and reporting.

In practice, movement of the primary node, for example, from one network to another, may cause a change in configuration if the secondary node also moves. In one example, if the primary node is an SGW, it has external IP addresses to communicate with the MME, eNodeB and PGW. If the SGW is relocated to another place, e.g. VM or a container in another HW node, there may be the same or different virtual IP address for the SGW. If the shadow or legal intercept agent vPOI 16 in the SGW is communicating to the shadow orchestrator using that same IP address, it would lose connectivity when the SGW IP address it relies on changes. In this example, once the SGW moves and the SGW IP changes, the vPOI 16 loses connection and it then re-learns a new SGW IP address. The vPOI 16 would then report new IP to the shadow orchestrator and re-establishes connectivity. Likewise, connections to the vMF 18 may be lost, so the vMF 18 could request an update of the new address from shadow orchestrator. Also, the vPOI 16 may contact the vMF 18 directly to reestablish connection using credentials that the vMF 18 can verify through the shadow orchestrator.

The shadow node operation or search component 30 is responsible for enabling the secondary virtual agents to share information related to the operations of their functions beyond the basic connectivity establishment learned through node discovery and initial configuration. In one embodiment, the shadow node search component enables indirect communications between any virtual agent, between any virtual agent and any shadow node component, and between any shadow node component. The shadow node search component 30 is associated with search data 31 to assist in configuring assembling agents into a coherent network service or feature capability. According to one embodiment, with legal intercept (LI), the vADMF 12 may post information about targets of interest, the vNI 14 may be able to identify targets in their network, the vPOI 16 may learn of the targets and which vMF 18 to send exfiltrated data to, the vMF may learn the standards to use for formatting for a given target and the vDF 20 to send formatted data to, and the vLEMF 22 may learn of various vADMFs to which it can send requests, as well as what vDFs support it. The shadow node search component 30 may be a server and the search data 31 may be any type of memory associated with the server.

In certain embodiments, the functions of the shadow node components or servers (26, 28, or 30) may be unified into a single virtual or physical platform or distributed across any number of platforms as a hybrid of virtual and physical types. Furthermore, in certain embodiments, the data stores (27, 29, or 31) associated with the shadow node components or servers may be unified into a single virtual or physical platform or distributed across any number of platforms as a hybrid of virtual and physical types.

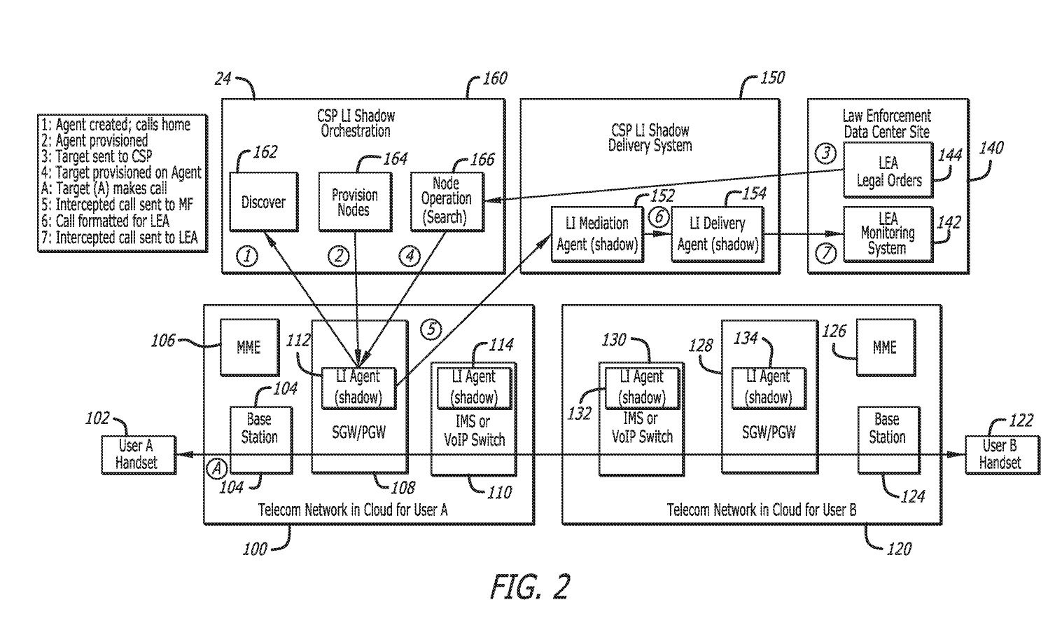

One embodiment of the shadow search orchestrator supports legal intercept of services and traffic supported by NFV components. FIG. 2 shows one embodiment of a network including a secondary or shadow agents to legally intercept data. In the embodiment shown the network is an LTE/IMS network. As shown, the telecom network includes network A 100 that may be in the Cloud. User A′s device 102 may be connected to network A 100. Network A 100 may include a base station 104, MME 106, SGW/PGW 108, and IMS or VoIP Switch 110. Furthermore, a first shadow LI agent 112 may be unconfigured and stored on or in communication with the SGW/PW 108. A second shadow LI agent 114 maybe be unconfigured and stored on or in communication with the IMS or VoIP switch 110. The telecom network also includes network B 120 that may also be in the Cloud. User B′s device 122 may be connected to network B 120. Network B 120 may include a base station 124, MME 126, SGW/PGW 128, and IMS or VoIP Switch 130. Furthermore, a third shadow LI agent 132 may be unconfigured and stored on or in communication with the SGW/PW 128. A fourth shadow LI agent 134 maybe be unconfigured and stored on or in communication with the IMS or VoIP switch 130. As described below, the LI agents may be created or configured and provisioned to intercept information from a target device.

The network of FIG. 2 also includes a law enforcement data center 140, which may be found on a server, a private Cloud, or at a law enforcement site using non-virtualized legacy equipment. The law enforcement data center 140 may include virtual agents such as a monitoring system 142 and a legal orders agent 144.

Also, a communication service provider (CSP) legal intercept shadow delivery system 150 may be on the network shown in FIG. 2. The CSP maybe any regulated carrier, such as a mobile network, ISP, OTT providers, etc. The delivery system 150 may include virtual agents such as a LI mediation agent 152 and an LI delivery agent 154. In a preferred embodiment, the delivery system may be a part of the CSP. However, the delivery system may be on a separate server or share the same server as the law enforcement data center site.

FIG. 2 also shows the network including a CSP LI shadow orchestration component 160. As described above with reference to FIG. 1, the shadow orchestration component 160 includes a discovery node 162, a configuration or provision node 164, and an operation or search node 166. The shadow orchestration component may be a part of the CSP in a preferred embodiment. However, the shadow orchestration component may be installed on the same server hosting the delivery system and law enforcement data center or it may be located on a separate server in the Cloud. The agents, components, and nodes described and shown in FIG. 2 may be the same or similar agents that were previously described with respect to FIG. 1. In another embodiment, not shown in FIG. 2, a MANO may be a part of network A to provision the primary node components (base station 104, MME 106, SGW/PGW 108, IMS or VoIP switch 110) in order to distinguish the primary node from the secondary or shadow orchestration.

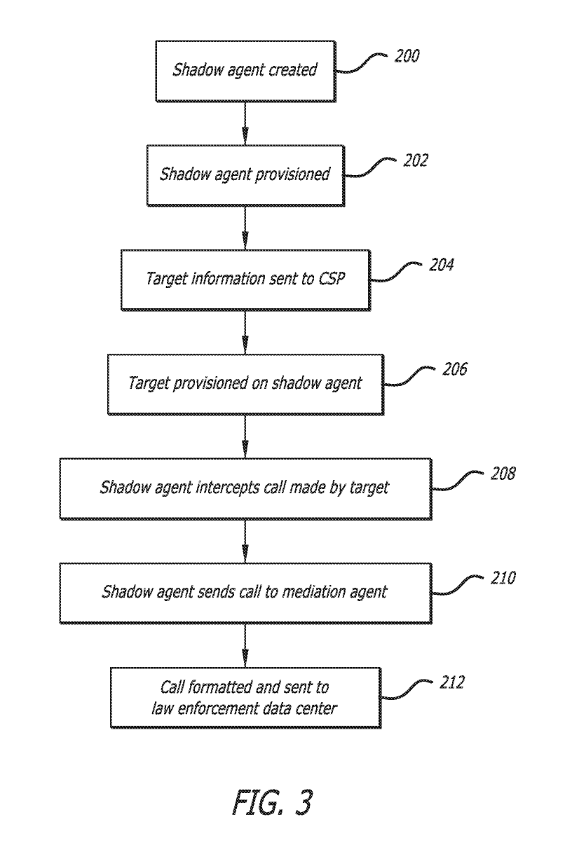

One embodiment of the method of the LI network shown in FIG. 2 will now be described with reference to the flow chart of FIG. 3. Once a law enforcement agency has authorization to legally intercept a communication from a target user or device, such as the handset 102 of user A, LI shadow agent 112 or LI shadow agent 114, or both, are active or created at step 200. Once the shadow agent is active or created it may communicate with the discovery node 162 of the CSP shadow orchestration so that the shadow agent becomes discoverable by other agents in the shadow network. Next at step 202, the configuration or provision node 164 will provision the activated shadow agent 112. Once active, the shadow agent 112 may begin intercepting or tapping a communication if it is a target. At step 204, the legal orders agent 144 sends target information to the search or operation node 166. The target information is then provisioned on the shadow agent 112 by the search or operation node 166 at step 206. Once the target device, handset 102, makes a call or sends data to another user or device, such as handset 122, the shadow agent intercepts the call or data at the SGW/PGW 108 at step 208. In one embodiment, a call on the network may trigger the shadow agent 112 to query the operation or search node 166 to see if the call is on the target list, and if it is, the shadow agent 112 will intercept the call. The shadow agent 112 sends the intercepted call or data to the mediation agent 152 at step 210. The intercepted call or data may then be formatted by for the law enforcement data center by the delivery agent 154 once it receives the intercepted call or data from the mediation agent 152 at step 212. Also at step 212, the delivery agent 154 may send the formatted call or data to the monitoring system 142 of the law enforcement data center so the call or data may be reviewed by law enforcement.

In another embodiment described below, the SSO is performed by a Network Orchestration System (NOS). Legal intercept (LI) requires that a number of secondary shadow components be instantiated, configured, and interconnected to support interception of metadata and content traffic from a set of primary components that make up the telecommunications/Internet network. The primary components include base stations, mobility managers (e.g. Mobility Management Entity (MME)), packet gateways (e.g. Serving GPRS Serving Node (SGSN), Gateway GPRS Serving Node (GGSN), Serving Gateway (SGW), PDN Gateway (PGW)), and other core network nodes (e.g. Home Location Register (HLR), Home Subscriber Server (HSS), Policy & Charging Rules Function (PCRF)).

According to one embodiment, a home register may be provided by a service provider network including a replication control system. The home register may be a 2G/3G home location register (HLR), a 4G home subscriber server (HSS). It is noted that the home register can cover other types of network protocols and technologies including IP, Worldwide Interoperability for Microwave Access (WiMax) without deviating from the scope of the present disclosure.

The secondary (virtual LI or vLI) components may include:

vADMF (virtual administrative functions)

vNI (virtual network intelligence functions)

vPOI (virtual point of interception functions)

vMF (virtual mediation functions)

vDF (virtual delivery functions)

vLEMF (virtual law enforcement monitoring functions).

In this embodiment, the primary nodes are orchestrated using a NFV MANO system. The MANO may also be used to instantiate generic versions of the secondary components, however, those secondary components would not initially know any other secondary components in the network. In some cases, the NOS causes the vLI components to be instantiated by the MANO.

The vPOI, however, would be configured with some basic information (e.g., geographic location) that enables them to be further configured as necessary. There may be two aspects to geolocation. The first being that the agent may find itself in some location for which a legal jurisdiction may or may not apply. The second being the policy for how that agent operates may be applied based on that jurisdiction. In one example, an agent that says it is in the United States may be configured to operate by rules of the United States. Also, an agent that is in Canada may then be configured to operate by Canadian rules. The vPOI may be embedded in the NFV from which they are designed to extract specific types of data. The vADMF and vLEMF could be configured initially with its location and the organization that it will support. The vNI, vMF, and vDF may also have information about location or what organizations they support. All of them are given the network address and credentials to securely communicate with the NOS (SSO).

In this embodiment, upon initialization, the vLI components perform a registration operation with the NOS to let it know they exist and to request further configuration data to bootstrap up to full capability. In this way, the MANO is performed with its instantiation process without knowing the details of the vLI functions, and the NOS can perform the secondary orchestration within its functional domain.

The NOS itself may be a virtualized function that post boot-up could be further configured as to where the sensitive data is located for further booting up the rest of the vLI functions.

The separation of the NOS from the vADMF enables the vADMF to focus on the administrative functions of the legal process without having to keep track of the dynamic actions taking place in the various monitored networks. The vADMF mainly needs to know how to connect to the NOS to deliver targeting and delivery information.

The vNI function includes instructions to contact the NOS for further configuration and instructions. Once fully bootstrapped, it can be given dynamic targets to be watching for in the network so it can perform notifications and other functions to enable the NOS to know where the targets are located in the network.

The vPOI function (which may be embedded in a primary NFV) includes instructions to contact the NOS for further configuration and instructions. The NOS then informs it of the current targets of interest (may be learned from vNI), the nature of what data it must extract, and the address and credentials of the vMF to which it must connect for data exfiltration. The NOS could use vPOI location information reported along with jurisdiction maps to select the proper vMF and subsequent functions.

The vMF includes instructions to contact the NOS for further configuration and instructions. The NOS then informs the vMF about the vPOIs from which it will receive data along with the vDFs to which standards-based formatted reporting is required. Configuration includes the addresses and credentials of adjacent nodes, along with a subset of targets, standards, and reporting options to support.

The vDF includes instructions to contact the NOS for further configuration and instructions. The NOS then informs the vDF about the vMFs from which it will receive formatted metadata and content streams and to which vLEMFs those reporting streams should be delivered to. Configuration includes the addresses and credentials of adjacent nodes, along with delivery options.

The vLEMF includes instructions to contact the NOS for further configuration and instructions. The NOS could then inform the vLEMF about the organizations which it will support, the credentials of the vDFs from which it will receive information, as well as information about which end-users will have access to the vLEMF.

Due to the dynamic nature of the presence of user traffic on the network, the dynamic and elastic nature of the network itself, the secondary shadow vLI system also dynamically adapts and reconfigures itself without revealing sensitive information to the primary NFV network and its MANO orchestrator. The SSO 10, which is the NOS in this embodiment, manages the derivative vLI configurations based on the learned primary configuration changes.

The detailed description is to be construed as exemplary only and does not describe every possible embodiment since describing every possible embodiment would be impractical, if not impossible. Numerous alternative embodiments could be implemented, using either current technology or technology developed after the filing date of this application.

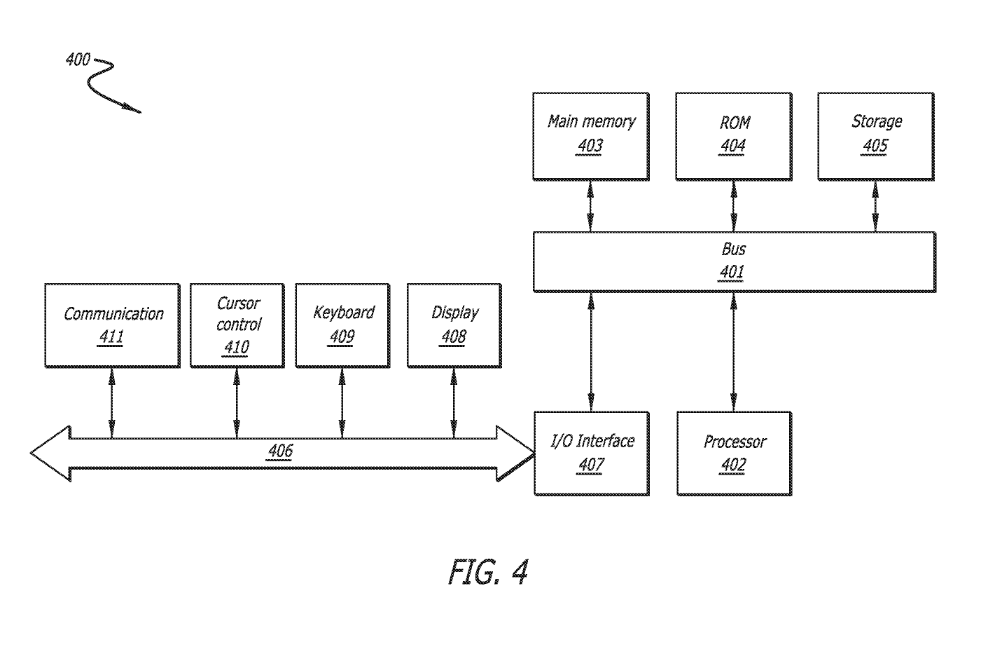

FIG. 4 illustrates an exemplary computer architecture that may be used for the present system, according to one embodiment. The exemplary computer architecture may be used for implementing one or more components, e.g., the server and mobile handset devices, described in the present disclosure including, but not limited to, the present system. One embodiment of architecture 400 includes a system bus 401 for communicating information, and a processor 402 coupled to bus 401 for processing information. Architecture 400 further includes a random access memory (RAM) or other dynamic storage device 403 (referred to herein as main memory), coupled to bus 401 for storing information and instructions to be executed by processor 402. Main memory 403 also may be used for storing temporary variables or other intermediate information during execution of instructions by processor 402. Architecture 400 may also include a read only memory (ROM) and/or other static storage device 404 coupled to bus 401 for storing static information and instructions used by processor 402.

A data storage device 405 such as a magnetic disk or optical disc and its corresponding drive may also be coupled to architecture 400 for storing information and instructions. Architecture 400 can also be coupled to a second I/O bus 406 via an I/O interface 407. A plurality of I/O devices may be coupled to I/O bus 406, including a display device 408, an input device (e.g., an alphanumeric input device 409 and/or a cursor control device 410).

The communication device 411 allows for access to other computers (e.g., servers or clients) via a network. The communication device 411 may include one or more modems, network interface cards, wireless network interfaces or other interface devices, such as those used for coupling to Ethernet, token ring, or other types of networks.

While the present disclosure has been described in terms of particular embodiments and applications, summarized form, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the scope of the present disclosure.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. An augmented telecommunication system, comprising:
a network including virtual network functions;
a secondary agent located on the network;
a node discovery server in communication with the secondary agent over the network;
a node configuration server in communication with the secondary agent; and
a node search server in communication with the secondary agent over the network;
wherein the secondary agent monitors information passing over the network.

2. The system of claim 1, further comprising a plurality of virtual agents in communication with the secondary agent over the network.

3. The system of claim 2, wherein the plurality of virtual agents include virtual network intelligence agent, virtual point of interception agent, virtual mediation agent, virtual delivery agent, virtual law enforcement monitoring agent, or various management agents.

4. The system of claim 1, wherein the node discovery server is in communication with a data store to assist in validating the secondary agent.

5. The system of claim 1, wherein the node configuration server is in communication with a data store to assist in configuring the secondary agent.

6. The system of claim 2, wherein the node search server is in communication with a data store to assist in assembling the plurality of virtual agents into a coherent network service.

7. The system of claim 2, wherein the plurality of virtual agents and the secondary agent are embedded in the virtual network function of the network that upon activation spawn the initiation of the plurality of virtual agents and the secondary agent.

8. The system of claim 2, wherein the plurality of virtual agents and the secondary agent are stand-alone virtual network functions on the network that are spawned by the shadow node configuration server through requests to a management and orchestration architecture.

9. The system of claim 2, wherein the plurality of virtual agents and the secondary agent are pre-provisioned with boot-strapping information, such as authentication credentials and the network address of the node discovery server to contact.

10. The system of claim 9, wherein the boot-strapping information includes cryptographical material enabling it to establish encrypted confidential paths back to each of the node discovery server, the node configuration server, and the node search server.

11. The system of claim 9, wherein the boot-strapping information includes parameters of operation of the plurality of virtual agents and the secondary agent to enable them to transform from an unconfigured state to a configured state.

12. The system of claim 11, wherein the parameters of operation include parameters such as network operator, jurisdiction, and geolocation.

13. The system of claim 11, wherein the parameters of operation include parameters such as data transmission policies governing what can be transmitted and how packets should be marked for quality of service.

14. The system of claim 11, wherein the parameters of operation include parameters such as assigned work group and other virtual agents from which to receive data connection requests and which virtual agents it can request connections.

15. The system of claim 11, wherein the parameters of operation include parameters such as assigned shadow node managing servers from which it receives instructions and to which it provides reports.

16. The system of claim 11, wherein the parameters of operation include parameters such as start and end times for operations associated with its internal functions.

17. The system of claim 11, wherein the parameters of operation include parameters for spawning additional virtual agents to support scaling out.

18. The system of claim 11, wherein the parameters of operation include parameters for requesting additional compute, storage, or communications resources to support scaling up.

19. The system of claim 11, wherein the parameters of operation include parameters indicating the allowable information that can be requested by another component on the network.

20. The system of claim 11, wherein the parameters of operation include parameters indicating allowable information to be shared with other components on the network.
